(19) United States
(12) Patent Application Publication
(10) Pub. No.: US 2012/0018424 A1
(43) Pub. Date: Jan. 26, 2012

(54) COOKING APPARATUS WITH STEAM GENERATING DEVICE

(76) Inventors: Kazuhiko Inoue, Aichi-ken (JP); Eiji Suzuki, Aichi-ken (JP); Shinichi Kaga, Aichi-ken (JP); Yukimasa Takeda, Aichi-ken (JP); Akihiko Hirano, Aichi-ken (JP)

(21) Appl. No.: 13/060,104

(22) PCT Filed: Aug. 20, 2009
(86) PCT No.: PCT/JP2009/064554

§ 371 Date: Oct. 11, 2011

(30) Foreign Application Priority Data
Aug. 20, 2008 (JP) 2008-212026
Jul. 27, 2009 (JP) 2009-174497

(51) Int. Cl. H05B 6/12

(52) U.S. Cl. 219/620

(57) ABSTRACT

Object

Provide a cooking device with a steam generating device having a reduced size and capable of producing steam in a short time.

Means of Solution

A cooking apparatus comprising a cooking chamber for accommodating foodstuff in its interior for cooking, a heater for heating interior of said cooking chamber and an electric fan for generating convectional flow of air heated by said heater in said cooking chamber, characterized in that, an induction heating type steam generating device for supply steam into said cooking chamber is disposed on the side wall of said cooking chamber, wherein said steam generating device comprises a steam generating vessel which store prescribed amount of water, an induction heater body disposed in said steam generating vessel for heating water and an induction heating coil wound around outer peripheral of said steam generating vessel for heating said induction heater.

### TECHNICAL FIELD OF THE INVENTION

This invention relates to a cooking apparatus having a steam generating device such as steam convection oven.

### BACKGROUND TECHNOLOGIES

The Patent Publication 1 below discloses a cooking apparatus comprised of a cooking chamber for accommodate foodstuff inside for cooking, a heater for heating the interior of the cooking chamber, an electric fan disposed to generate convectional air flow of hot air heated by the heater in the cooking chamber and a steam generator for supplying steam to the cooking chamber. The steam generating device of this cooking apparatus has a steam generating heater comprised of a coil shape sheath heater disposed in a cylindrical vessel and it generates steam by heating water supplied in the cylindrical container.

The Patent Publication 2 below discloses an electromagnetic induction heating device having a hot plate and a steam generating plate both are induction heated by a work coil. In this electromagnetic induction heating device, steam is generated by heating water supplied into steam generating gutter formed in the steam generating plate.

### PRIOR ART

Patent Publication 1: Japanese Laid-open Publication No.2008-032266

Patent Publication 2: Japanese Laid-open Publication No. 2004-150644

### DISCLOSURE OF THE INVENTION

### Problems to be Solved by the Invention

In the steam generating device of the cooking apparatus disclosed in Patent Publication 1, water level stored in the cylindrical vessel must be maintained higher than the upper end tip of the steam generating heater to prevent overheating of steam generating heater, since it utilizes a sheath heater. Thus, amount of water stored in the vessel is large and it takes long time for generating steam.

A high output heater having long heat generating portion is used as the steam generating heater to supply sufficient amount of steam into the cooking chamber. The heater continuing in whole length of it has to be wound in coil shape or bent in zigzag shape to accommodate in the cylindrical vessel. Thus, the cylindrical vessel which accommodates the heater has to be large and it stores large amount of water, so it takes long time to generating steam.

In the electromagnetic induction heating apparatus disclosed in Patent Publication 2, temperature inside the cooking chamber may drop by water which does not vaporized, since it generates steam by heating s water flowing in the gutter formed in the steam generating plate, water which does not vaporized may flow into the cooking chamber together with steam.

### Means to Solve the Problem

An object of the present invention is to provide a cooking apparatus comprising a cooking chamber for accommodating foodstuff in its interior for cooking, a heater for heating interior of said cooking chamber and an electric fan for generating convectional flow of air heated by said heater in said cooking chamber, characterized in that, an induction heating type steam generating device for supply steam into said cooking chamber is disposed on the side wall of said cooking chamber, wherein said steam generating device comprises a steam generating vessel which store prescribed amount of water, an induction heater body disposed in said steam generating vessel for heating water and an induction heating coil wound around outer peripheral of said steam generating vessel for heating said induction heater.

In practice of the present invention, efficiency of steam generation can be enhanced by utilizing plurality of metallic stick shaped electrically conductive material as induction heater which disposed in said steam generating vessel.

In the cooking apparatus of the present invention configured as described above, the steam generating device is an induction heating device comprised of the steam generating vessel for storing prescribed amount of water, the induction heater body disposed in the steam generating vessel and the induction heating coil wound around outer peripheral of the steam generating vessel for induction heating the induction heater body. It is possible to lower the water level in the steam generating vessel as low as just submerge the portion of the induction heater body which heated by induction heating coil, the small amount of water to be stored in the steam generating vessel is enough. Thus, it is possible to make the device smaller and shorten the time for generating steam.

### BRIEF DESCRIPTION OF THE DRAWINGS

FIG. 1 is a front view of the cooking apparatus according to the present invention.

FIG. 2 is a lateral cross-sectional view at A-A line in FIG. 1.

FIG. 3 is a vertical cross-sectional view at B-B line in FIG. 2.

FIG. 4 is a vertical cross-sectional view at C-C line in FIG. 2.

FIG. 5 is a drawing illustrating the operating panel.

FIG. 6 is a block chart illustrating control device of the cooking apparatus according to the present invention.

### DESCRIPTION OF THE PREFERRED EMBODIMENTS

Hereinafter describe a steam convection oven which is an embodiment of cooking apparatus of the present invention referring to the drawings. The cooking apparatus 10 comprises the cooking chamber a cooking chamber 11 for accommodating foodstuff inside, a heater 20 for heating interior of the cooking chamber 11, an electric fan 30 for generating convectional flow of air heated by said heater in the cooking chamber and steam generating device 40 for supplying steam into the cooking chamber 11. The steam generating device 40 in this cooking apparatus 11 is an induction heating type steam generating device which comprised of a steam generating vessel 41 which store prescribed amount of water, an induction heater body 42 disposed in the steam generating vessel 41 for heating water and an induction heating coil 43 wound around outer peripheral of the steam generating vessel 41 for heating said induction heater.

This cooking apparatus 10 has an oven cooking mode, a steam cooking mode and combined cooking mode. In the oven cooking mode, foodstuff placed in the cooking chamber 11 is cooked with hot air flow generated by the heater 20 and the electric fan 30. In the steam cooking mode, the foodstuff placed in the cooking chamber cooked with steam flow generated by the steam generating device 40 and the electric fan 30. In the combined cooking mode, foodstuff placed in the cooking chamber 11 is cooked with hot air flow and steam flow generated by the heater 20, steam generating device 40 and the electric fan 30. This cooking apparatus 10 has a manual mode and a program mode. In the manual mode, selection of cooking modes above, cooking temperature, thickness of steam and cooking time can be set freely to suit cooking method for the foodstuff. In the program mode, cooking mode, cooking temperature, steam thickness and cooking time are preset to suit cooking method of the foodstuff.

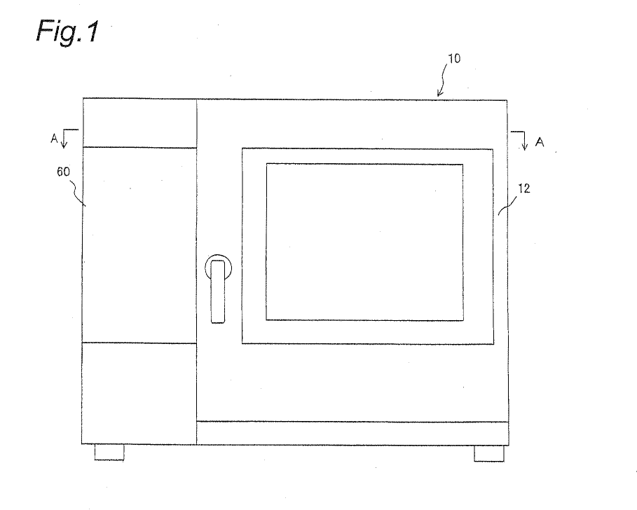

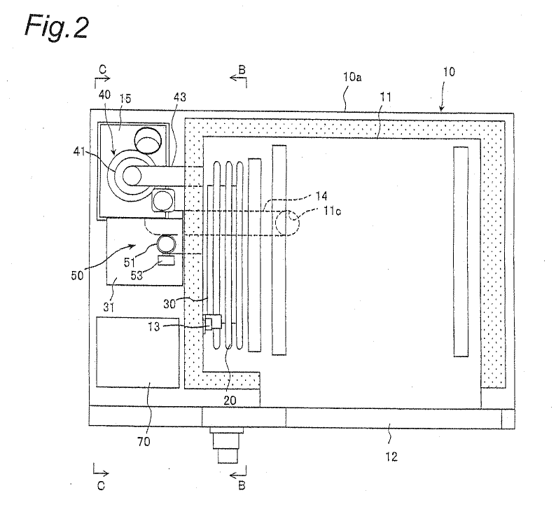

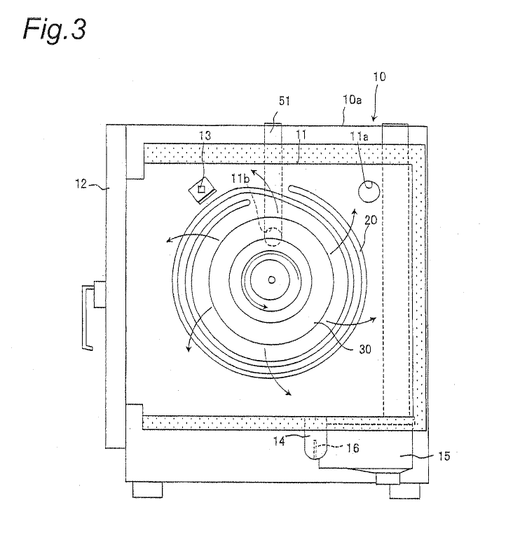

As illustrated in FIGS. 1 and 2, cooking chamber 11 is made to accommodate foodstuff for cooking. It has an opening in front face of box shaped outer shall and heat insulated door 12 is mounted for foodstuff to go through there. In the cooking chamber 11, a cooking chamber temperature sensor 13 utilizing thermocouple is placed for detecting inside temperature of cooking chamber 11. As illustrated in FIGS. 2 and 3, the cooking chamber 11 comprises a steam inlet 11a a passage for steam generated by steam generating device 40, a port 11b for air to go in and out from the cooking chamber 11 and a port 11c for draining water from the cooking chamber 11. The port 11c provided in cooking chamber 11 is connected with a drain tube 14. The drain tube 14 is connected with a drain tank 15 also act as drainage for steam generator 40. The air in the cooking chamber 11 containing steam is discharged through drain tube 14 and drain tank 15. An exhaust temperature sensor 16 is provided in the drain tube 14 for detecting temperature of exhaust air.

As illustrated in FIGS. 2 and 3, the heater 20 is a conventional electric heater such as sheathed heater for heating interior of the cooking chamber 11 with supplied electricity and is disposed inside left wall of the cooking chamber 11 in circular shape.

As illustrated in FIGS. 2 and 3, the electric fan 30 is a centrifugal fan such as sirocco fan for generating convectional air flow in the cooking chamber 11 with supplied electricity and is mounted on the left inside wall of the cooking chamber. The electric fan 30 is surrounded by the heater 20 which disposed in a circular shape. The electric fan 30 driven by a fan motor 31 blows the air onto the heater 20 to generate convectional flow of hot air in the cooking chamber 11.

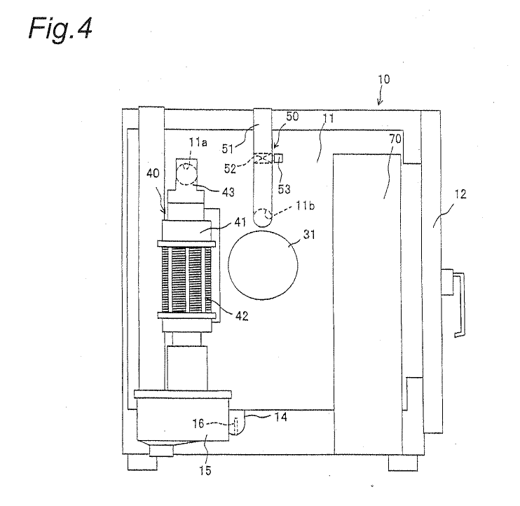

As illustrated in FIGS. 2 and 4, steam generating device 40 which supply steam into the cooking chamber 11 with supplied electricity and is disposed left side position of the cooking chamber in a casing 10a. The steam generating device 40 is an induction heating type steam generator which comprises cylindrical shape steam generating vessel 41, an induction heater body 42 consists of metallic stick shape electro conductive material disposed inside of the steam generating vessel 41 and an induction heating coil 43 wound around outer peripheral of the steam generating vessel 41. The induction heating coil 42 supplied with high frequency electric current heats the induction heater body to evaporate the water in the steam generating vessel 41 thus the steam generator 40 generates steam. A steam supply tube 44 connected to the steam induction port 11a is disposed on the upper end of the steam generating vessel 41. The steam generated in the steam generating vessel 41 is flow into the cooking chamber 11 through the steam supply tube 44. The bottom end of the steam generating vessel 41 is attached to the drain tank 15 for draining the water in the cooking chamber 11. The water in the steam generator vessel 41 is discharged to outside through drain tank 15. Water is stored in the steam generating vessel 41 at level slightly higher than the height of wound induction heating coil 43.

As illustrated in FIGS. 2 and 4, a vent device 50 is provided which comprises vent tube 51, vent valve 52 consists of butterfly valve disposed in the vent tube 51 and a vent valve motor 53 for activating the vent valve 52. The vent tube 51 is connected with the port 11b disposed in the left side wall of the cooking chamber 11 and back side of the electric fan 30. The vent valve 52 is rotatably disposed in the middle portion of the vent tube 51 and is driven by the vent valve motor 53 to vary its opening for adjusting the air flow through the vent tube 51. When the vent valve 52 of the vent device 50 opened with the electric fan 30 running, the air outside the cooking chamber 11 is introduced into the cooking chamber 11 through the vent tube 51. When the vent valve 52 opened with the electric fan 30 is not running, the air in the cooking chamber exhausted to the outside of the cooking chamber 11 by the steam supplied by steam generating device 40 or the steam vapored from the foodstuff through the vent tube 51.

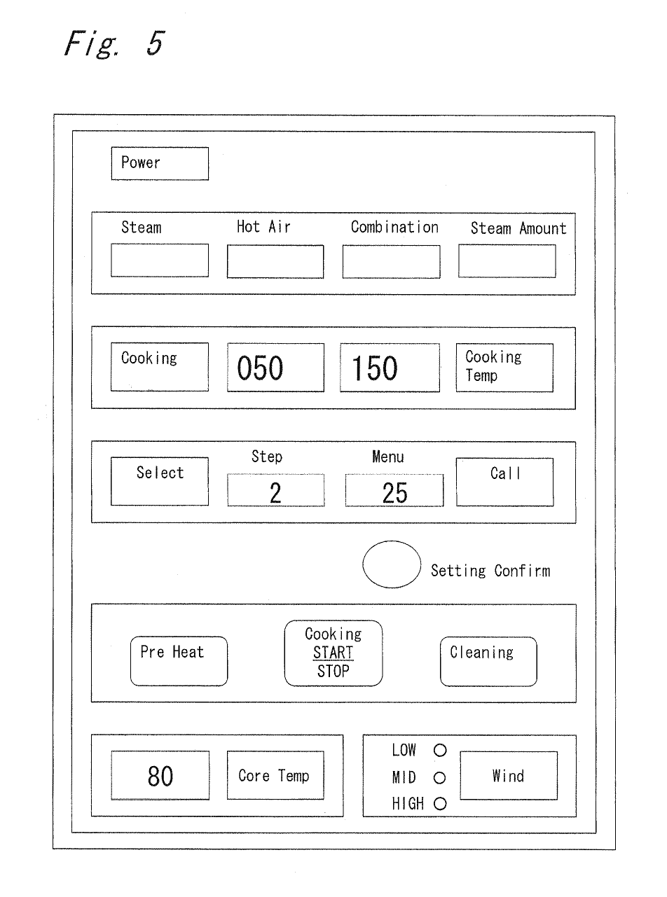

As illustrated in FIGS. 1 and 5, an operation panel 60 is provided for setting cooking mode, cooking temperature and cooking time (main-heating time period). The operation panel 60 comprises “Steam”, “Hot Air” and “Combination” buttons. These buttons are provided for selection of cooking modes which are steam cooking mode, oven cooking mode and combined cooking mode in manual cooking. The operation panel 60 comprises “Cooking Time” and “Cooking Temperature” buttons. These buttons are provided for setting cooking time (main-heating time period) and cooking temperature. The operation panel 60 comprises “Select” and “Menu” buttons. These buttons are provided for selecting pre-programed cooking programs in the program mode in which said cooking mode, cooking temperature and cooking time (main-heating time period) are preset.

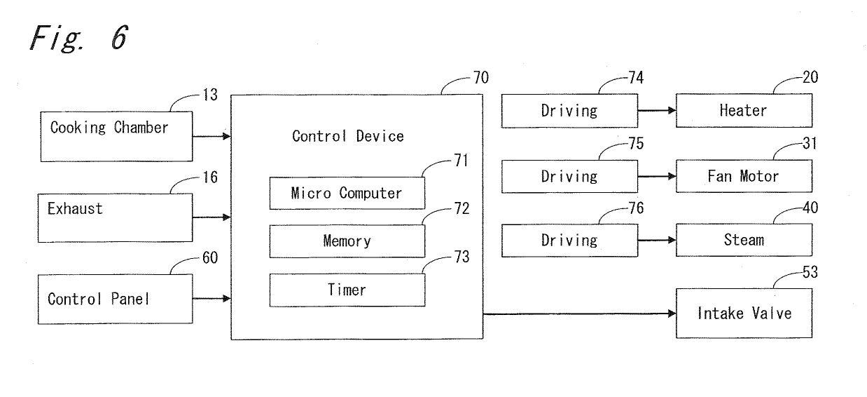

As illustrated in FIG. 6, the cooking apparatus 10 comprises the cooking chamber temperature sensor 13, the exhaust temperature sensor 16, the heater 20, the fan motor 31, the steam generating device 40, the vent motor 53 and a controller 70 having microcomputer 71 which is connected with the operation panel 60. The controller 70 comprises a memory 72 and a timer 73. The memory 72 stores cooking program in the program mode. The timer 73 is provided for counting elapsed cooking time.

The controller 70 comprises drive circuits 74-76, which are connected to the heater 20, the fan motor 31 and the steam generating device 40. The driving circuit 74 is a phase control circuit, which changes electricity supply for the heater 20 by changing phase of voltage. The driving circuit 75 and 76 are inverter circuits, which changes electricity supply for the fan motor 31 and the steam generating device 40 by increasing or decreasing driving time of switching element. The controller 70 controls output of the heater 20, speed of the fan motor 31 and steam amount of the steam generating device 40 by means of the driving circuits 74-76 variably control the input electricity for the heater 20, the fan motor 31 and steam generating device 40. In this embodiment, the driving circuits 74-76 are utilizing phase control circuit and inverter circuit. However, it is not limited to these. The variable control of supply electricity for devices 20, 31 and 40 may be accomplished by utilizing other circuit.

The controller 70 comprises a control means which controls activation of the heater 20 as follows; rise the inside temperature of the cooking chamber 11 up to preset cooking temperature suitable for cooking the foodstuff in response to the temperature detected by the cooking chamber temperature sensor 13 in the pre-heating processing as the pre-heating processing, after the pre-heating processing, when the inside temperature of the cooking chamber 11 dropped by placing the foodstuff in the cooking chamber 11, rise the inside temperature of the cooking chamber 11 up to the preset cooking temperature again as the initial-heating processing and then after the initial-heating processing is completed, maintain the inside temperature of the cooking chamber 11 at preset cooking temperature during predetermined main-heating processing time period in response to the temperature detected by the cooking chamber temperature sensor 13. The controller 70 controls activation of the steam generating device 40 to maintain steam thickness in the cooking chamber 11 at predetermined steam thickness during main-heating processing in response to temperature detected by the exhaust temperature sensor 16.

In the cooking apparatus configured as described above, the steam generating device 40 is an induction heating type steam generating device which comprises the steam generating vessel for storing prescribed amount of water, the induction heater body 42 disposed in the steam generating vessel and the induction heating coil 43 wound around outer peripheral of the steam generating vessel 41. In the conventional steam generating device utilizing an electric heater such as sheath heater instead of induction heater body 42 heated by the induction heating coil 43, the water level must be kept higher than the upper end tip of the electric heater to prevent overheating. Thus, the amount of water in the steam generating vessel is large, so it takes long time to generating steam. In comparison with the above, the steam generating device 40 of the cooking apparatus 10 according to the present invention comprises the induction heater body 42 heated by the induction heating coil 43. It is possible to lower the water level in the steam generating vessel 41 to the height higher than the portion of the induction heater body 42 which heated by the induction heating coil 43, not as high as upper end tip of the induction heater body 42. Thus, the amount of water in the steam generating vessel 41 is small, so that it is possible to generate steam in short time.

In the conventional steam generating device utilizing an electric heater such as sheath heater instead of the induction heater body 42 heated by the induction heating coil 43, the heater continuing in whole length of it has to be wound in coil shape or bent in zigzag shape to accommodate in the cylindrical vessel. Thus, the cylindrical vessel which accommodates the heater has to be large and it stores large amount of water, so it takes long time to generating steam. In comparison with the above, the steam generating device 40 of the cooking apparatus 10 according to the present invention utilizes the induction heater body comprised of plurality of metallic stick shape electrically conductive material having sufficient surface area for generating prescribed amount of heat which is disposed in the steam generating vessel 41 in parallel to each other. Thus, it is possible to make the induction heater body 42 small in size, so that it is possible to lessen the amount of water stored in the steam generating vessel 41 for generating steam in short time.

### DESCRIPTION OF THE NUMERALS

10 . . . Cooking Apparatus (Steam Convection Oven), 11 . . . Cooking Chamber, 20 . . . Heater, 30 . . . Electric Fan, 40 . . . Steam Generating Device, 41 . . . Steam Generating Vessel, 42 . . . Induction Heater Body, 43 . . . Induction Heating Coil

1. A cooking apparatus comprising a cooking chamber for accommodating foodstuff in its interior for cooking, a heater for heating interior of said cooking chamber and an electric fan for generating convectional flow of air heated by said heater in said cooking chamber,
characterized in that, an induction heating type steam generating device for supply steam into said cooking chamber is disposed on the side wall of said cooking chamber, wherein said steam generating device comprises a steam generating vessel which store prescribed amount of water, an induction heater body disposed in said steam generating vessel for heating water and an induction heating coil wound around outer peripheral of said steam generating vessel for heating said induction heater.

2. A cooking apparatus as claimed in claim 1, utilizing plurality of metallic stick shaped electrically conductive material as induction heater body which disposed in said steam generating vessel.
